(19) United States
(12) Patent Application Publication
(10) Pub. No.: US 2025/0026374 A1
(43) Pub. Date: Jan. 23, 2025

(54) Vehicle for Search for Shoulder Stop Position During Autonomous Driving and Operating Method Thereof

(71) Applicants: Hyundai Motor Company, Seoul (KR); Kia Corporation, Seoul (KR)

(72) Inventors: Chan Jong Jang, Daegu (KR); Young Bin Min, Busan (KR); Jong Sung Park, Hwaseong-si (KR)

(21) Appl. No.: 18/423,709

(22) Filed: Jan. 26, 2024

(30) Foreign Application Priority Data
Jul. 18, 2023 (KR) 10-2023-0093085

(51) Int. Cl. B60W 60/00

(52) U.S. Cl. CPC B60W 60/0015; B60W 2520/10; B60W 2556/40

(57) ABSTRACT

An autonomous vehicle is provided which includes: at least one sensor configured to detect surrounding environment of the vehicle and to generate surrounding environment information; a processor, during autonomous driving of the vehicle, configured to generate vehicle state information by monitoring a state of the vehicle, and to determine whether a minimum risk maneuver (MRM) is required based on at least one of the surrounding environment information and the vehicle state information; and a controller configured to control operations of the vehicle under the control of the processor, wherein, based on a determination that the MRM is required, the processor is configured to determine an MRM type, and when the determined MRM type is a shoulder stop, the processor is configured to generate at least one stop position candidate group.

### CROSS REFERENCE TO RELATED APPLICATION

This application claims the priority and benefits of Korean Patent Application No. 10-2023-0093085, filed on Jul. 18, 2023, which is incorporated herein by reference in its entirety.

### BACKGROUND

Some advanced driver assistance systems (ADAS) are being developed to assist a driver of a vehicle for the driving of the vehicle. The ADAS has multiple sub-classifications of technologies and provides convenient functions and/or operations to the driver. Such ADAS is also called autonomous driving or autonomous driving system (ADS).

Meanwhile, an abnormality may occur in an autonomous driving system while a vehicle performs autonomous driving. The vehicle may be in a dangerous situation if appropriate measures to such abnormality of the autonomous driving system are not performed.

### SUMMARY

The following summary presents a simplified summary of certain features. The summary is not an extensive overview and is not intended to identify key or critical elements.

Accordingly, various examples of the present disclosure disclose a vehicle that searches for an optimal stop position when shoulder stop is required as a minimum risk maneuver strategy during autonomous driving.

The present disclosure provides a method for operating the vehicle that searches for an optimal stop position when shoulder stop is required as the minimum risk maneuver strategy during autonomous driving.

The technical problems to be solved by the present disclosure are not limited to the above-mentioned technical problems. Other technical problems not explicitly mentioned herein can be understood from the present disclosure by a person having ordinary skill in the art.

A vehicle may comprise: at least one sensor configured to detect surrounding environment of the vehicle and to generate surrounding environment information; a processor, during autonomous driving of the vehicle, configured to generate vehicle state information by monitoring a state of the vehicle, and to determine whether a minimum risk maneuver (MRM) is required based on at least one of the surrounding environment information and the vehicle state information; and a controller configured to control operations of the vehicle under the control of the processor, wherein, based on a determination that the MRM is required, the processor is configured to determine an MRM type, and when the determined MRM type is a shoulder stop, the processor is configured to generate at least one stop position candidate group.

The processor may be configured to: recognize, based on the surrounding environment information, a shoulder area, partition the shoulder area into a plurality of virtual areas, determine a score of each of the virtual areas, wherein the score is determined based on at least one of: a speed of the vehicle, a free space on the shoulder area, or a distance from a current position of the vehicle to a stop position of the vehicle, and generate, based on the determined score of each of the virtual areas, the at least one stop position candidate group.

The processor may be configured to assign a predetermined score to a virtual area, of the plurality of virtual areas, comprising an obstacle.

The processor may be configured to: match a virtual window area corresponding to a size of the vehicle to the plurality of virtual areas; and generate the at least one stop position candidate group based on a value obtained by summing the scores of the respective virtual areas included in the virtual window area.

The processor may be configured to: after generating the at least one stop position candidate group, generate a path from a current position of the vehicle to each stop position candidate of the at least one stop position candidate group.

The processor may be configured to: select a final stop position based on at least one of: a travel distance of the path from the current position to each stop position candidate, a stop characteristic of the vehicle after following the path from the current position to each stop position candidate, or values obtained by adding scores of virtual areas of an area occupied by the vehicle after following the path from the current position to each stop position candidate.

The processor may be configured to generate, based on stored map data, a first selection score for each travel distance that is based on the path from the current position to a respective stop position candidate.

The processor may be configured to generate, based on the stored map data, a second selection score for each stop characteristic of the vehicle after following the path from the current position to a respective stop position candidate.

The processor may be configured to: generate, for a respective stop position candidate, a final score based on the first selection score, the second selection score, and a third selection score that is obtained by adding the scores of the respective virtual areas of an area occupied by the vehicle after following the path from the current position to a respective stop position candidate, and select, as the final stop position, a stop position candidate having a highest final score among the final scores of the respective stop position candidates.

The processor may be configured to transmit, to the controller, a path-following control command for the final stop position.

The processor may be configured to generate, based on a determination that the vehicle fails to arrive at the final stop position within a preset time, a stop position candidate group for changing the stop position.

An operation method of a vehicle may comprise: during autonomous driving of the vehicle: generating surrounding environment information by detecting surrounding environment of the vehicle; generating vehicle state information by monitoring a state of the vehicle; determining whether a minimum risk maneuver (MRM) is required based on at least one of the surrounding environment information and the vehicle state information; and determining an MRM type based on a determination that the MRM is required, and generating at least one stop position candidate group when the determined MRM type is a shoulder stop.

The generating the at least one stop position candidate group may comprise: partitioning, based on a shoulder area being recognized from the surrounding environment information, the shoulder area into a plurality of virtual areas; determining a score of each of the virtual areas, wherein the score is determined based on at least one of: a speed of the vehicle, a free space on the shoulder area, or a distance from a current position of the vehicle to a stop position of the vehicle; and generating, based on the determined score of each of the virtual areas, the at least one stop position candidate group.

The generating the at least one stop position candidate group may comprise: matching a virtual window area corresponding to a size of the vehicle to the plurality of virtual areas; and generating the at least one stop position candidate group based on a value obtained by summing the scores of the respective virtual areas included in the virtual window area.

The operating method may further comprise: after generating the at least one stop position candidate group, generating a path from a current position of the vehicle to each stop position candidate of the at least one stop position candidate group.

The operating method may further comprise: after generating a path from the current position of the vehicle to each stop position candidate of the at least one stop position candidate group, selecting a final stop position based on at least one of: a travel distance of the path from the current position to each stop position candidate, a stop characteristic of the vehicle after following the path from the current position to each stop position candidate, or a score of each of virtual areas of an area occupied by the vehicle after following the path from the current position to each stop position candidate.

The selecting the final stop position may comprise: generating, based on stored map data, a first selection score for each travel distance that is based on the path from the current position to a respective stop position candidate; generating, based on the stored map data, a second selection score for each stop characteristic of the vehicle after following the path from the current position to a respective stop position candidate; and generating a third selection score by adding the scores of the respective virtual areas of an area occupied by the vehicle after following the path from the current position to a respective stop position candidate.

The operating method may further comprise: after the generating the third selection score: generating, for a respective stop position candidate, a final score based on the first selection score, the second selection score, and the third selection score; and selecting, as the final stop position, a stop position candidate having a highest final score among the final scores of the respective stop position candidates.

The operating method may further comprise: after selecting the final stop position, controlling the vehicle to follow a path to the final stop position.

The operating method may further comprise: after controlling the vehicle to follow the path to the final stop position, generating, based on a determination that the vehicle fails to arrive at the final stop position within a preset time, a stop position candidate group for changing the stop position.

These and other features and advantages are described in greater detail below.

### BRIEF DESCRIPTION OF THE DRAWINGS

FIG. 1 is a block diagram of example components of a vehicle;

FIG. 2 is a block diagram of a processor;

FIG. 3 shows a minimal risk maneuver (MRM) strategy for each state of a vehicle;

FIGS. 4A and 4B show an example in which the vehicle determines the MRM strategy based on surrounding environment information within a specified MRC range;

FIG. 5 shows an example of changing a priority of the MRM strategy in accordance with surrounding object information within the specified MRC range in the vehicle;

FIGS. 6A, 6B, and 6C show an example in which the vehicle determines, by the MRM, whether an own vehicle collides with a nearby vehicle;

FIG. 7 shows an example in which the vehicle determines the MRM strategy of the own vehicle in consideration of whether to collide with a nearby vehicle by the MRM of the own vehicle;

FIGS. 8A and 8B show an example in which the vehicle calculates a distance from a nearby vehicle;

FIG. 9 is a flowchart showing operations of the vehicle;

FIG. 10 is a flowchart showing that the vehicle determines the MRM strategy;

FIG. 11 is a flowchart for showing a shoulder stop operation during autonomous driving;

FIG. 12 shows an example in which the vehicle grids a shoulder area;

FIG. 13 shows an example in which the vehicle generates an optimal stop position candidate group;

FIG. 14 shows an example of the optimal stop position candidate group;

FIG. 15 shows an example in which the vehicle generates an optimal path; and

FIGS. 16 and 17 show an example in which the vehicle generates an optimal stop position candidate group.

### DETAILED DESCRIPTION

Hereinafter, various examples of the present disclosure will be described in detail with reference to the accompanying drawings.

The configuration of the present disclosure and details of the consequent effect will be more clearly understood in view of the following detailed description. Prior to the detailed description of the present disclosure, the same components are denoted by the same reference numerals as much as possible even though they are depicted in different drawings. It should be noted that the detailed description may be omitted when the known configurations may make the subject matter of the present disclosure unclear.

Prior to the detailed description of the present disclosure, terms used in the present disclosure may be explained and/or defined as follows.

A vehicle may be equipped with an autonomous driving system (ADS) and thus can be autonomously driven. For example, the vehicle may perform at least one of steering, acceleration, deceleration, lane change, and stopping (e.g., without a driver's manipulation) by the ADS. The ADS may include, for example, at least one of pedestrian detection and collision mitigation system (PDCMS), lane change decision aid system (LCAS), land departure warning system (LDWS), adaptive cruise control (ACC), lane keeping assistance system (LKAS), road boundary departure prevention system (RBDPS), curve speed warning system (CSWS), forward vehicle collision warning system (FVCWS), low speed following (LSF), etc.

A driver may be a person who uses a vehicle and is provided with a service of an autonomous driving system.

A vehicle control authority may control at least one component of the vehicle and/or at least one function of the vehicle. The at least one function of the vehicle may include, for example, a steering function, an acceleration function, a deceleration function (or a braking function), a lane change function, a lane detection function, a lateral control function, an obstacle recognition and distance detection function, a powertrain control function, a safety zone detection function, an engine on/off function, a power on/off function, and a vehicle lock/unlock function. The listed functions of the vehicle are only examples for understanding, and the embodiments of the present disclosure are not limited thereto.

A shoulder (or a shoulder area) may refer to a space between the outermost road boundary (the outermost lane boundary) in a traveling direction of the vehicle and a road edge (e.g., kerb, guardrail).

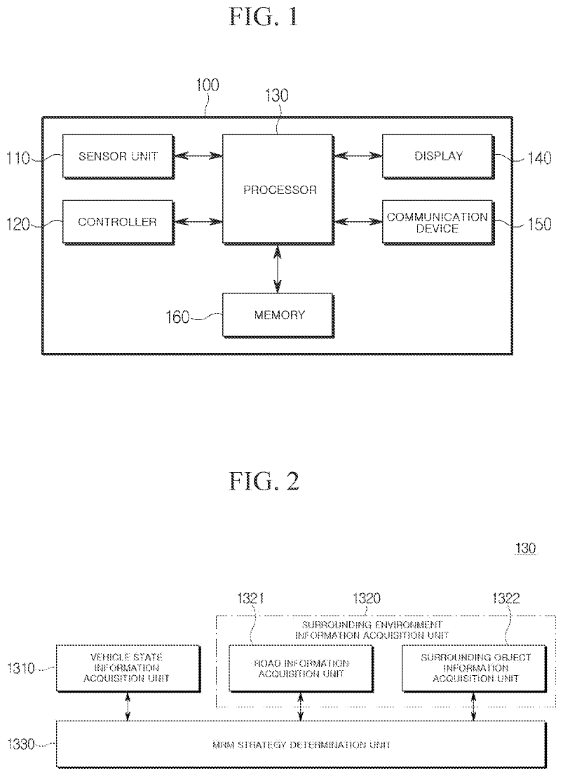

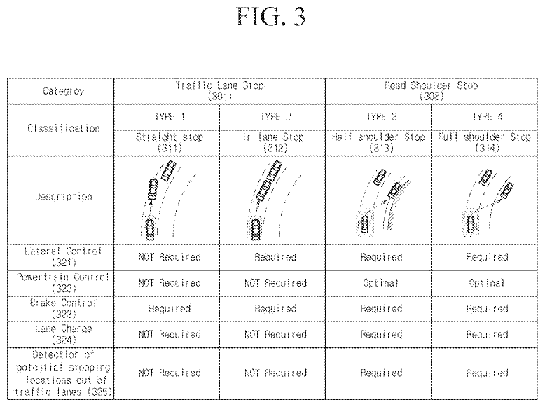

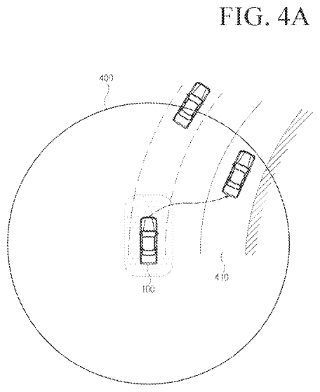

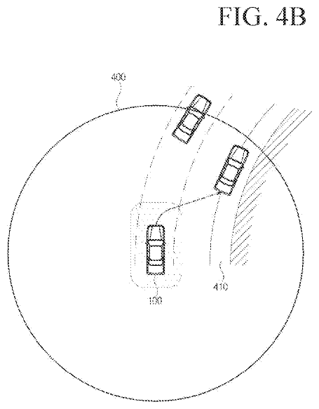

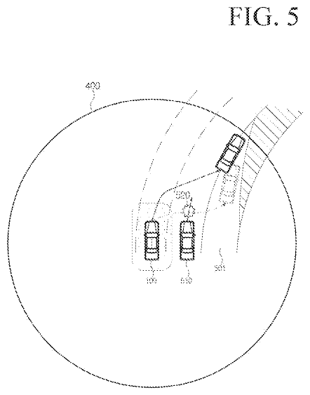

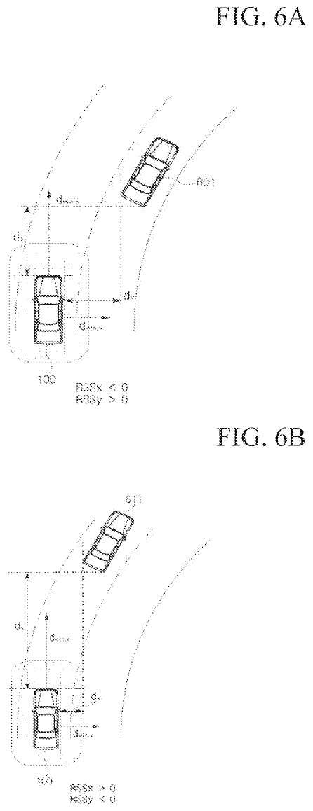

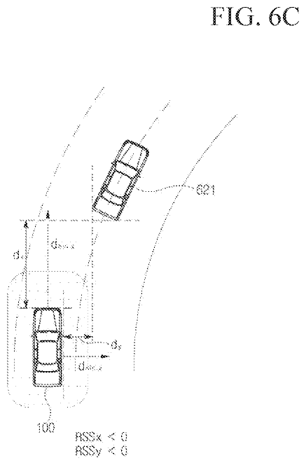

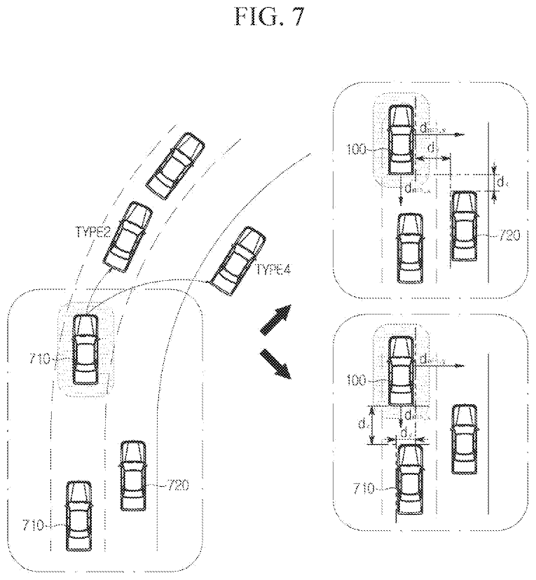

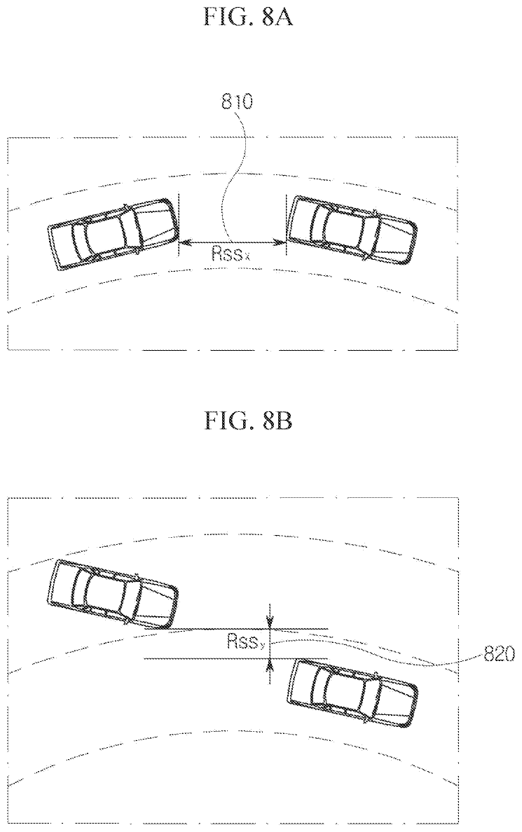

FIG. 1 is a block diagram of an example vehicle. Each component of the vehicle (e.g., including an electronic device) may be configured with one chip, one part, or one electronic circuit or configured by combining chips, parts, and/or electronic circuits. Some of the components shown in FIG. 1 may be divided into a plurality of components and may be configured with different chips, parts or electronic circuits. Also, some components may be combined and configured with one chip, one part, or one electronic circuit. Some of the components shown in FIG. 1 may be omitted or components not shown may be added. At least some of the components of FIG. 1 will be described with reference to FIGS. 2 to 8. FIG. 2 is a functional block diagram of a processor. FIG. 3 shows a minimal risk maneuver (MRM) strategy for each state of a vehicle. FIGS. 4A and 4B show an example in which the vehicle determines the MRM strategy based on surrounding environment information within a specified MRC range. FIG. 5 shows an example of changing a priority of the MRM strategy in accordance with surrounding object information within the specified MRC range in the vehicle. FIGS. 6A to 6C show an example in which the vehicle determines, by the MRM, whether the own vehicle collides with a nearby vehicle. FIG. 7 shows an example in which the vehicle determines the MRM strategy of the own vehicle in consideration of whether to collide with a nearby vehicle by the MRM of the own vehicle. FIGS. 8A and 8B show an example in which the vehicle calculates a distance from a nearby vehicle.

Referring to FIG. 1, a vehicle 100 may include a sensor unit 110 (e.g., including one or more sensors), a controller 120, a processor 130, a display 140, a communication device 150, and a memory 160.

The sensor unit 110 may detect the surrounding environment of the vehicle 100 by using at least one sensor and may generate data related to the surrounding environment on the basis of the detection result. Based on the sensing data obtained from at least one sensor, the sensor unit 110 may acquire road information, information on objects around the vehicle (e.g., other vehicles, people, objects, curbs, guardrails, lanes, obstacles) and/or vehicle location information. The road information may include, for example, at least one of lane location, lane shape, lane color, lane type, the number of lanes, the presence or absence of a shoulder, or the size of the shoulder. The object around the vehicle may include, for example, at least one of a position of the object, a size of the object, a shape of the object, a distance to the object, and a relative speed to the object.

The sensor unit 110 may include at least one of a camera, a light detection and ranging (LIDAR), a radio detection and ranging (RADAR), an ultrasonic sensor, an infrared sensor, and a position measuring sensor. The listed sensors are only examples for understanding, and the sensors included in the sensor unit 110 of the present disclosure are not limited thereto. The camera may capture the surroundings of the vehicle and may generate image data including lanes and/or surrounding objects at the front, rear and/or side of the vehicle 100. The LIDAR may generate information on the objects located at the front, rear and/or side of the vehicle 100 by using light (or laser). The RADAR may generate information on the objects located at the front, rear, and/or side of the vehicle 100 by using electromagnetic waves (or radio waves). The ultrasonic sensor may generate information on the objects located at the front, rear, and/or side of the vehicle 100 by using ultrasonic waves. The infrared sensor may generate information on the object located at the front, rear, and/or side of the vehicle 100 by using infrared light. The position measuring sensor may measure the current position of the vehicle 100. The position measuring sensor may include at least one of a global positioning system (GPS) sensor, a differential global positioning system (DGPS) sensor, and a global navigation satellite system (GNSS) sensor. The position measuring sensor may generate vehicle position data on the basis of a signal generated by at least one of the GPS sensor, the DGPS sensor, and the GNSS sensor.

The controller 120 may control the operations of at least one component of the vehicle 100 and/or of at least one function of the vehicle under the control of the processor 130. The at least one function may include, for example, a steering function, an acceleration function (or a longitudinal acceleration function), a deceleration function (or a longitudinal deceleration function, a brake function), a lane change function, a lane detection function, an obstacle recognition and distance detection function, a lateral control function, a powertrain control function, a safety zone detection function, an engine on/off function, a power on/off function, and a vehicle lock/unlock function.

The controller 120 may control the operation of at least one function of the vehicle and/or and at least one component of the vehicle for the purpose of autonomous driving and/or minimal risk maneuver (MRM) of the vehicle 100 under the control of the processor 130. For example, the controller 120 may control the operation of at least one of the steering function, the acceleration function, the deceleration function, the lane change function, the lane detection function, the lateral control function, the obstacle recognition and distance detection function, the powertrain control function, and the safety zone detection function.

The processor 130 may control overall operation of the vehicle 100. The processor 130 may include an electrical control unit (ECU) capable of integrally controlling components within the vehicle 100. For example, the processor 130 may include a central processing unit (CPU) or a micro processing unit (MCU) which is capable of performing calculation processing.

The processor 130 may control components in the vehicle 100 so that the vehicle performs autonomous driving by activating an automated driving system (ADS) when a specified event occurs. The designated event may occur when a driver's autonomous driving is requested, a vehicle control authority is delegated from the driver, or a condition specified by the driver and/or a designer is satisfied.

The processor 130 may determine whether normal autonomous driving is possible, on the basis of at least one of vehicle state information and surrounding environment information during the autonomous driving. If normal autonomous driving is infeasible (e.g., impossible), the processor 130 may determine the MRM strategy and may control the determined MRM strategy to be performed. Here, the MRM strategy may include an MRM type.

The processor 130 may include, as shown in FIG. 2, a vehicle state information acquisition unit 1310, a surrounding environment information acquisition unit 1320, and an MRM strategy determination unit 1330.

The vehicle state information acquisition unit 1310 may monitor the mechanical and/or electrical states of the components (e.g., a sensor, an ADS processor, an actuator, etc.) within the vehicle from a point of time when the ADS is activated, and may acquire the vehicle state information that indicates whether the mechanical faults and/or electrical faults of the internal components of the vehicle occur. The vehicle state information may include information on the mechanical and/or electrical states of the components within the vehicle. For example, the vehicle state information may include information indicating whether or not functions required for the autonomous driving are normally operable according to mechanical and/or electrical states of the internal components of the vehicle.

The surrounding environment information acquisition unit 1320 may acquire the environment information on the surroundings of the vehicle by using the sensor unit 110 and/or the communication device 150 from the point of time when the ADS is activated. The surrounding environment information acquisition unit 1320 may include a road information acquisition unit 1321 that acquires information on a road on which the vehicle is traveling, and a surrounding object information acquisition unit 1322 that detects objects around the vehicle from the sensor unit 110.

The road information acquisition unit 1321 may acquire, through the sensor unit 110, road information on where the vehicle is traveling. The road information acquisition unit 1321 may acquire map information from an external device (e.g., another vehicle or a server) through the communication device 150, and may acquire, on the basis of the map information, the road information on where the vehicle is traveling.

The surrounding object information acquisition unit 1322 may acquire information on objects (e.g., other vehicles, people, objects, kerbs, guardrails, lanes, obstacles) around the vehicle through the sensor unit 110. For example, the surrounding object information acquisition unit 1322 may obtain a distance and a relative speed to at least one vehicle located at the side front, side, and/or side rear of the vehicle.

The processor 130 may determine whether or not functions required for the autonomous driving are normally operable, based on the vehicle state information. The function required for the autonomous driving may include, for example, at least one of a lane detection function, a lane change function, a lateral control function, a deceleration (or brake control) function, a powertrain control function, a safety zone detection function, and an obstacle recognition and distance detection function. If at least one of the functions required for the autonomous driving cannot normally operate, the processor 130 may determine that normal autonomous driving is infeasible (e.g., impossible).

The processor 130 may determine whether the state of the vehicle is suitable for general driving conditions, on the basis of the vehicle state information. For example, the processor 130 may determine whether mechanical state information (e.g., tire pressure information or engine overheating information) of the vehicle is suitable for general driving conditions. If the state of the vehicle is not suitable for general driving conditions, the processor 130 may determine that normal autonomous driving is infeasible (e.g., impossible). For example, if the normal driving of the vehicle is infeasible (e.g., impossible) due to tire air pressure or engine overheating, the processor 130 may determine that normal autonomous driving is infeasible (e.g., impossible).

Based on at least one of pieces of surrounding environment information, the processor 130 may determine whether an environment around the vehicle is suitable for an operation design domain (ODD) of autonomous driving. The operation design domain may represent conditions of the surrounding environment in which autonomous driving is normally performed. If the surrounding environment information of the vehicle does not conform to the operation design domain, the processor 130 may determine that normal autonomous driving is infeasible (e.g., impossible).

If normal autonomous driving is infeasible (e.g., impossible), the processor 130 may determine that it is necessary to perform the minimum risk maneuver for minimizing the risk of an accident. If it is determined that the minimum risk maneuver is required to be performed, the processor 130 may select one minimum risk maneuver strategy from among a plurality of minimum risk maneuver strategies by using the MRM strategy determination unit 1330. The minimal risk maneuver strategies may include (e.g., as shown in FIG. 3, four types) a plurality of types. For example, the minimal risk maneuver strategies may include a traffic lane stop 301 strategy including TYPE 1 and TYPE 2 and may include a road shoulder stop 303 strategy including TYPE 3 and TYPE 4.

The traffic lane stop 301 strategy may include a straight stop 311 of TYPE 1 and an in-lane stop 312 of TYPE 2. The road shoulder stop 303 strategy may include a half-shoulder stop 313 of TYPE 3 and a full-shoulder stop 314 of TYPE 4.

The straight stop 311 of TYPE 1 is a type in which the vehicle is stopped by using only brake control 323 that is a longitudinal deceleration function. The straight stop 311 does not involve lateral control. For example, the straight stop 311 may be performed in a situation where at least one of lateral control 321, powertrain control 322, lane change 324, and detection of potential stopping location out of traffic lane 325 is infeasible (e.g., impossible). For example, the straight stop may be performed in a situation where the lateral control is infeasible (e.g., impossible) due to the fault in an actuator and the lane detection is infeasible (e.g., impossible). Here, the detection of potential stopping location out of traffic lane may be a function of detecting the position of a safety zone located outside the traffic lane, such as a shoulder or a rest stop.

The in-lane stop 312 of TYPE 2 is a type in which the vehicle stops within the boundary of the lane in which the vehicle is traveling. For example, the in-lane stop 312 may refer to a type in which the vehicle stops within the boundary of the lane in which the vehicle is traveling through the lateral control 321 and/or the brake control 323. The lane in which the vehicle is traveling may refer to a lane in which the vehicle is traveling at a point of time when the minimum risk maneuver is determined to be necessary. The in-lane stop 312 may be performed in a situation in which at least one of the powertrain control 322, the lane change 324, or the detection of potential stopping location out of traffic lane 325 is impossible.

The half-shoulder stop 313 of TYPE 3 is a type in which the vehicle stops in a state where a part of the vehicle is positioned on the shoulder of the road. For example, the half-shoulder stop 313 may refer to a type in which the vehicle moves such that a part of the vehicle is positioned on the shoulder out of the road boundary (or out of the outermost lane boundary) through the lateral control 321, the brake control 323, the lane change 324, and/or the detection of potential stopping location out of traffic lane 325 and then the vehicle stops.

The full-shoulder stop 314 of TYPE 4 is a type in which the vehicle stops in a state where the entire vehicle is positioned on the shoulder of the road. For example, the full-shoulder stop 314 may refer to a type in which the vehicle moves such that the entire vehicle is positioned on the shoulder out of the road boundary (or out of the outermost lane boundary) through the lateral control 321, the brake control 323, the lane change 324, and/or the detection of potential stopping location out of traffic lane 325 and then the vehicle stops.

Priority of the aforementioned MRM types may be determined based on roads, surrounding environment, and fail-operational capability that a vehicle is able to tolerate faults. For example, in order to minimize the risk of stopping, the MRM types corresponding to the road shoulder stop 303 strategy may have a higher priority than that of the MRM types corresponding to the traffic lane stop 301 strategy. Also, the priority of the MRM types corresponding to the full-shoulder stop 314 may be set to be higher than the priority of the MRM types corresponding to the half-shoulder stop 313, and the priority of the MRM types corresponding to the in-lane stop 312 may be set to be higher than the priority of the MRM types corresponding to the straight stop 311. That is, the priority of the MRM types may be determined to be reduced in the order of the full-shoulder stop 314, the half-shoulder stop 313, the in-lane stop 312, and the straight stop 311.

The MRM strategy determination unit 1330 of the processor 130 may select the MRM strategy on the basis of at least one of the vehicle state information and the surrounding environment information.

The MRM strategy determination unit 1330 may check the MRM type that is performable among the above-described MRM types, on the basis of a function that normally operates and/or a function that cannot normally operate among functions required for autonomous driving based on the vehicle state information. For example, when the lateral control function operates normally, the MRM strategy determination unit 1330 may determine that the straight stop 311, the in-lane stop 312, the half-shoulder stop 313, and the full-shoulder stop 314 of the performable MRM type can all be performed. As another example, when the lateral control function does not normally operate, the performable MRM type may be determined as the straight stop 311.

If there is one performable MRM type checked based on the vehicle state information, the MRM strategy determination unit 1330 may determine the corresponding MRM type as the MRM strategy. For example, when the lateral control function does not normally operate, only the straight stop 311 can be performed. Therefore, the MRM strategy determination unit 1330 may determine the straight stop 311 as the MRM strategy. As another example, when a driving lane is not detected due to sensor faults and/or external environment, only the straight stop 311 can be performed. Therefore, the MRM strategy determination unit 1330 may determine the straight stop 311 as the MRM strategy.

If there is a plurality of performable MRM types checked based on the vehicle state information, the MRM strategy determination unit 1330 may select the MRM type that can be performed within a specified minimum risk condition (MRC) range. A specified MRC range may be set and/or changed by business operators and/or designers. The specified MRC range may be set differently according to the performance of the vehicle, the type of the vehicle, and/or external environmental factors (e.g., weather, time, etc.).

The MRM strategy determination unit 1330 may determine the MRM type that can be performed within the MRC range, on the basis of whether a shoulder exists within the specified MRC range. If a shoulder does not exist within the specified MRC range, the MRM strategy determination unit 1330 may determine the MRM type that can be performed within the MRC range as the in-lane stop 312 and the straight stop 311.

If a shoulder exists within the specified MRC range, the MRM strategy determination unit 1330 may determine the MRM type that can be performed within the MRC range on the basis of the size of the shoulder. If the size of the shoulder within the specified MRC range is greater than or equal to a specified size, the MRM strategy determination unit 1330 may determine the MRM type that can be performed within the MRC range as the full-shoulder stop 314, the half-shoulder stop 313, the in-lane stop 312, and the straight stop 311. The specified size may be determined based on the size of the vehicle. If the size of the shoulder is smaller than the specified size, the MRM strategy determination unit 1330 may determine the MRM type that can be performed within the MRC range as the half-shoulder stop 313, the in-lane stop 312, and the straight stop 311.

If there is a plurality of MRM types that can be performed within the specified MRC range, the MRM strategy determination unit 1330 may select a final MRM strategy in consideration of the priority and/or surrounding object information.

If there is a plurality of MRM types that can be performed within the specified MRC range, the MRM strategy determining unit 1330 may select an MRM type having the highest priority among the MRM types that can be performed within the specified MRC range as a final MRM strategy. For example, as shown in FIG. 4A, when a width of a shoulder 410 within the specified MRC range 400 is greater than a width of the vehicle 100, the MRM strategy determination unit 1330 may select the full-shoulder stop 314 having the highest priority among the MRM types that can be performed within the MRC range 400 as a final MRM strategy. As another example, as shown in FIG. 4B, when a width of a shoulder 420 within the specified MRC range 400 is less than the width of the vehicle 100, the MRM strategy determination unit 1330 may select the half-shoulder stop 313 having the highest priority among the MRM types that can be performed within the MRC range 400 as a final MRM strategy.

The MRM strategy determination unit 1330 may select a final MRM strategy by additionally considering the degree of risk according to the implementation of the MRM strategy within the specified MRC range. For example, as shown in FIG. 5, it is assumed that a shoulder 501 exists within the MRC range 400, a width of an area adjacent to the vehicle 100 among an area of the shoulder 501 within the MRC range 400 is greater than the width of the vehicle 100, and a width of an area far from the vehicle 100 is less than the width of the vehicle 100. That is, it is assumed that the shoulder 501 of which the width gradually decreases within the MRC range 400 exists. In this case, the MRM strategy determination unit 1330 may select the full-shoulder stop 314 having the highest priority based on the width of the shoulder 501. However, during performing the full-shoulder stop 314, if there is a risk of collision (or rear-end collision) 520 with another vehicle 510, the MRM strategy determination unit 1330 may select the half-shoulder stop 313 having a priority lower than that of the full-shoulder stop 314 and having no risk of rear-end collision with another vehicle 510 as a final RMR strategy.

If there is a plurality of MRM types that can be performed within the specified MRC range, the MRM strategy determination unit 1330 may select a final MRM strategy in consideration of a possibility of collision and whether the responsibility of an accident exists. On the basis of a travel path for each of the MRM types that can be performed within the specified MRC range, the MRM strategy determination unit 1330 may determine a possibility of collision with nearby vehicles and whether the responsibility of an accident exists in the event of a collision. With respect to the full-shoulder stop and/or the half-shoulder stop which require a lane change, the MRM strategy determination unit 1330 may determine a possibility of collision with a vehicle located on the side front, a vehicle located on the side, and/or a vehicle located on the side rear of the own vehicle among nearby vehicles, and whether the responsibility of an accident exists. With respect to the in-lane stop which does not require the lane change, the MRM strategy determination unit 1330 may determine a possibility of collision with a vehicle located on the rear among nearby vehicles of the own vehicle, and whether the responsibility of an accident exists.

In order to determine a possibility of collision with nearby vehicles and whether the responsibility of an accident exists, on the basis of responsibility sensitivity safety (RSS) model shown in the following equations 1 and 2, the MRM strategy determination unit 1330 may calculate a safe distance which represents a difference between a minimum relative distance from a nearby vehicle and an actual relative distance from the nearby vehicle, and may determine a possibility of collision and whether the responsibility of an accident exists on the basis of the calculated safe distance.

$$RSSx = {d}_{x} - {d}_{min , x} \qquad Equation ( 1 )$$

$$RSSy = {d}_{y} - {d}_{min , y}$$

Here, RSSx indicates a longitudinal safe distance, d_{min,x} indicates a minimum longitudinal relative distance that must be maintained from a nearby vehicle, and dₓ indicates an actual longitudinal relative distance between the own vehicle and a nearby vehicle. Also, RSSy indicates a transverse safe distance, d_{min,y} indicates a minimum transverse relative distance that must be maintained from a nearby vehicle, and d_{y} indicates an actual transverse relative distance between the own vehicle and a nearby vehicle.

If at least one of the longitudinal safe distance RSSx and the transverse safe distance RSSy from a nearby vehicle is positive, the MRM strategy determination unit 1330 may determine that there is a low (or no) possibility of collision with the nearby vehicle even if the MRM having a travel path related to the nearby vehicle is performed. Also, the MRM strategy determination unit 1330 may determine that the responsibility of an accident does not exist in the own vehicle even if a collision with a nearby vehicle occurs. For example, as shown in FIG. 6A, when the longitudinal safe distance RSSx from the vehicle (own vehicle) 100 to a front right vehicle 601 is negative and the transverse safe distance RSSy is positive, the MRM strategy determination unit 1330 may determine that there is a low possibility of collision with the front right vehicle 601 even if the MRM which requires a lane change (e.g., the half-shoulder stop and/or the full-shoulder stop) is performed, and may determine that the responsibility of an accident does not exist in the own vehicle even if a collision with the right front vehicle 601. As another example, as shown in FIG. 6B, when the transverse safe distance RSSy from the vehicle (own vehicle) 100 to a front vehicle 611 traveling in the same lane is negative and the longitudinal safe distance RSSx is positive, the MRM strategy determination unit 1330 may determine that there is a low possibility of collision with the front vehicle 611 even if the MRM which requires a lane change (e.g., the half-shoulder stop and/or the full-shoulder stop) is performed, and may determine that the responsibility of an accident does not exist in the own vehicle even if a collision with the front vehicle 611.

If both the longitudinal safe distance RSSx and the transverse safe distance RSSy from a nearby vehicle are negative, the MRM strategy determination unit 1330 may determine that there is a high possibility (or there is a possibility) of collision with the nearby vehicle when the MRM having a travel path related to the nearby vehicle is performed. Also, the MRM strategy determination unit 1330 may determine that the responsibility of an accident exists in the own vehicle when a collision with a nearby vehicle occurs. For example, as shown in FIG. 6C, when both the longitudinal safe distance RSSx and the transverse safe distance RSSy from the vehicle (own vehicle) 100 to a front right vehicle 621 are negative, the MRM strategy determination unit 1330 may determine that there is a high possibility of collision with the front right vehicle 621 when the MRM which requires a lane change (e.g., the half-shoulder stop and/or the full-shoulder stop) is performed. Also, since the lane change of the own vehicle may cause a collision with the front right vehicle 621, the MRM strategy determination unit 1330 may determine that the responsibility of an accident exists in the own vehicle when a collision with the front right vehicle 621 occurs.

If the possibility of collision with a nearby vehicle is determined to be high at the time of performing the MRM which requires a lane change, the MRM strategy determination unit 1330 may select the in-lane stop having a lower priority than the full-shoulder stop and the half-shoulder stop as a final MRM. Here, the MRM strategy determination unit 1330 may calculate the longitudinal safe distance and the transverse safe distance to a rear vehicle of the own vehicle, which travels in the same lane. If at least one of the longitudinal safe distance and the transverse safe distance to the rear vehicle is positive, the MRM strategy determination unit 1330 may determine that there is a low possibility of collision with the rear vehicle even if the in-lane stop is performed and the responsibility of an accident does not exist in the own vehicle even though the collision occurs, and then may select the in-lane stop as a final MRM. For example, as shown in FIG. 7, in a situation where the MRM is required to be performed, for the purpose of the full-shoulder stop of TYPE 4 having the highest priority, the vehicle (own vehicle) 100 may calculate the longitudinal and transverse safe distances to a side-rear vehicle 720. However, if both the longitudinal and transverse safe distances to the side-rear vehicle 720 are negative, there may be a high possibility of collision with the side-rear vehicle 720 due to the lane change for the full-shoulder stop, and the responsibility may exist in the own vehicle when a collision with the side-rear vehicle 720 occurs. Therefore, since the longitudinal and transverse safe distances between the vehicle (own vehicle) 100 and a rear vehicle 710 are both positive, the vehicle (own vehicle) 100 may select the in-lane stop of TYPE 2 having a lower priority than Type 4 as a final MRM strategy.

The longitudinal and transverse safe distances between the own vehicle and a nearby vehicle may be calculated by the following Equations 2 and 3.

The following Equation 2 is an equation for calculating the longitudinal safe distance Rssₓ 810 between the own vehicle Cr and a nearby vehicle Cf as shown in FIG. 8A. The following Equation 3 is an equation for calculating the transverse safe distance Rss_{y} 820 between the own vehicle Cr and the nearby vehicle Cf as shown in FIG. 8B.

$${Rss}_{x} = {v}_{x , r} p + \frac{{a}_{max , accel} {ρ}^{2}}{2} + \frac{{( {v}_{x , r} + ρ {a}_{max , accel} )}^{2}}{2 {a}_{min , brake}} - \frac{{v}_{x , r}^{2}}{2 {a}_{max , brake}} \qquad Equation ( 2 )$$

$$Equation ( 3 )$$

$${Rss}_{y} = μ + [ \frac{2 {v}_{y , r} ρ + {a}_{max , accel}^{lat} {ρ}^{2}}{2} + \frac{{( {v}_{y , r} + ρ {a}_{max , accel}^{lat} )}^{2}}{2 {a}_{min , brake}^{lat}} - ( \frac{2 {v}_{y , f} ρ - {a}_{max , accel}^{lat} {ρ}^{2}}{2} \pm \frac{{( {v}_{y , f} - ρ {a}_{max , accel}^{lat} )}^{2}}{2 {a}_{max , brake}} ) ]$$

Here, “ρ” means a reaction time, and “μ” means a transverse margin. “a_{min,brake}” means a minimum deceleration of the own vehicle, and “a_{max,accel}” means a maximum acceleration of the nearby vehicle. “a_{max,brake}” means a maximum deceleration of the nearby vehicle.

For calculating the transverse and/or longitudinal safe distances, parameters of the Equations 2 and 3 may be set as shown in Table 1 below.

TABLE 1

| Param | Value | |
|---|---|---|
| ρ | 0.5 | (s) |
| μ | 0.4 | (m) |
| α_{max, brake} | 6 | (m/s²) |
| α_{min, brake} | 8 | (m/s²) |
| α_{max, accel} | 0 | (m/s²) |
| α^{lat}_{min, brake} | 4 | (m/s²) |
| α^{lat}_{max, accel} | 0 | (m/s²) |

Parameter values of Table 1 of various embodiments of present disclosure are not limited thereto.

For selection of the final MRM strategy, the MRM strategy determination unit 1330 may store in the memory 160 supporting data on which the final MRM strategy is selected. The supporting data may include at least one of the presence or absence of a shoulder within the specified MRC range, the size of the shoulder (e.g., length and/or width), a safe distance from a nearby vehicle, the vehicle state information of the own vehicle, or lane detection information. The MRM strategy determination unit 1330 stores the supporting data on which the final MRM strategy is selected, thereby securing a ground for selecting an MRM strategy having a lower priority. For example, when the straight stop of TYPE 1 is selected as the final MRM strategy, the MRM strategy determining unit 1330 may store at least one of information indicating abnormal operations of the lateral control function, information indicating a steering angle, a steering speed, and a defect in a lane detection sensor, or a sensing value of the lane detection sensor in the memory 160. As another example, if a shoulder exists within the specified MRC range and the in-lane stop of TYPE 2 is selected as the final MRM strategy, the MRM strategy determination unit 1330 may store longitudinal and transverse safe distance information on at least one nearby vehicle calculated in the process of selecting the MRM strategy.

A corresponding MRM type can be selected. For example, the MRM strategy determination unit 1330 may determine the straight stop 311 because only the straight stop 311 is possible in a situation where the lateral control function does not operate normally. As another example, the MRM strategy determining unit 1330 may determine the straight stop 311 if a driving lane is not detected due to sensor faults and/or external environment.

The processor 130 may control information indicating that the minimum risk maneuver is being performed to be notified to another vehicle and/or a driver, while performing a control operation to stop the vehicle according to the final MRM strategy. The control operation to stop the vehicle may include a driving trajectory generation operation for stopping the vehicle and/or a lateral and/or longitudinal control operation following the generated driving trajectory. The processor 130 may control the display 140 to notify the driver that the vehicle is performing the minimal risk maneuver. As another example, the processor 130 may control the communication device 150 to notify another vehicle that the vehicle is performing the minimum risk maneuver. This is only an example for understanding, and the method for notifying that the minimum risk maneuver is being performed will not be limited thereto.

The processor 130 may perform a control operation to stop the vehicle according to the determined minimum risk maneuver (MRM) type, and may determine whether the MRC is satisfied. The MRC may mean a stationary state where the speed of the vehicle is zero. For example, the processor 130 may determine whether the vehicle 100 enters a stationary state in which the speed of the vehicle 100 is zero while the vehicle 100 performs at least one operation according to the determined final MRM type. The processor 130 may determine that the MRC is satisfied when the speed of the vehicle 100 is zero.

If the MRC is satisfied, the processor 130 may terminate the performing operation of the MRM and may switch the autonomous driving system (ADS) to a standby mode or an off state. After switching the autonomous driving system (ADS) to a standby mode or an off state, the processor 130 may control such that the vehicle control authority is transferred to the driver (or user).

The display 140 may visually display information related to the vehicle 100. For example, the display 140 may provide a variety of information related to the state of the vehicle 100 to the driver of the vehicle 100 under the control of the processor 130. The variety of information related to the state of the vehicle may include at least one of information indicating whether various components included in the vehicle and/or at least one function of the vehicle normally operate, and information indicating the driving state of the vehicle. The driving state of the vehicle may include, for example, at least one of a state in which the vehicle is being autonomously driven, a state in which the vehicle is performing the MRM, a state in which the MRM has been completed, and a state in which the autonomous driving has been ended.

The communication device 150 may communicate with an external device of the vehicle 100. The communication device 150 may receive data from the outside of the vehicle 100 or may transmit data to the outside of the vehicle 100 under the control of the processor 130. For example, the communication device 150 may perform communication by using a wireless communication protocol or a wired communication protocol.

Although the controller 120 and the processor 130 have been described as separate components in FIG. 1 described above, the controller 120 and the processor 130 may be integrated into one component.

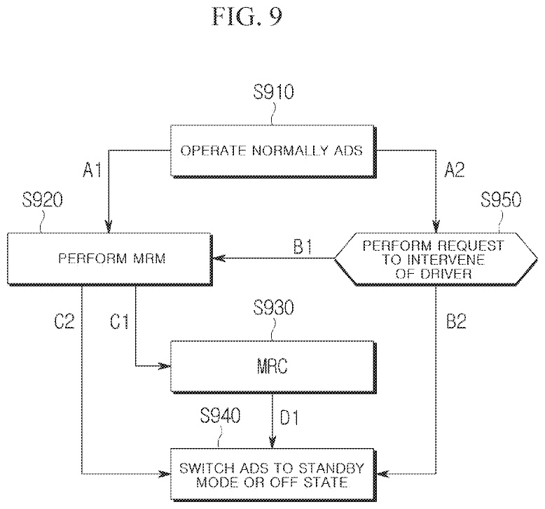

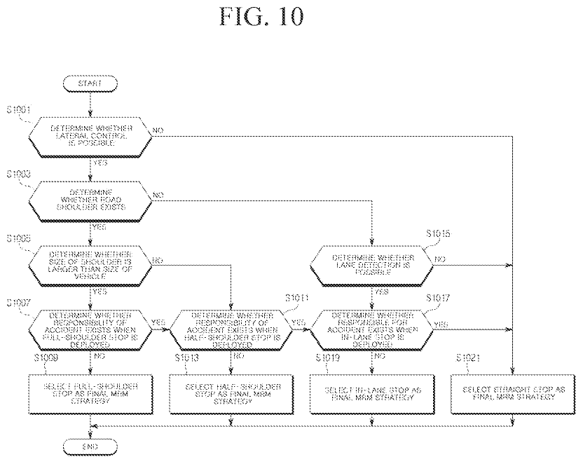

FIG. 9 is a flowchart showing operations of the vehicle. The vehicle of FIG. 9 may be the vehicle 100 of FIG. 1.

Referring to FIG. 9, the vehicle 100 may normally operate the ADS in step S910.

The vehicle 100 may monitor the vehicle state and the surrounding environment while performing the autonomous driving according to the normal operation of the ADS. The vehicle 100 may detect whether the minimum risk maneuver (MRM) is required, on the basis of information obtained by monitoring the vehicle state and the surrounding environment. If the minimum risk maneuver (MRM) is required, an event A1 may occur.

The vehicle 100 may detect whether the intervention of the driver (or user) is required, while performing the autonomous driving in accordance with the normal operation of the ADS. If the intervention of the driver is required, the vehicle 100 may perform a request to intervene (RTI) of the driver through the ADS or may issue a warning. The RTI of the driver or the warning may be an event A2. When the event A1 occurs while the ADS is normally operating, the vehicle 100 may proceed to step S920.

If the event A2 occurs while the ADS is normally operating, the vehicle 100 may determine whether the intervention of the driver is detected within a specified time in step S650. If the intervention of the driver is not detected within the specified time, the vehicle 100 may determine that an event B1 has occurred. If the event B1 has occurred, the vehicle 100 may proceed to step S920. If the intervention of the driver is detected within a specified time, the vehicle 100 may determine that an event B2 has occurred. When the event B2 has occurred, the vehicle 100 may proceed to step S940.

The vehicle 100 may perform the minimum risk maneuver (MRM) in step S920. The vehicle 100 may determine the MRM type on the basis of at least one of the vehicle state information and surrounding environment information. The surrounding environment information may include road information and information on surrounding vehicles. As shown in FIG. 3, the surrounding environment information may include the straight stop 311 of the TYPE 1, the in-lane stop 312 of the TYPE 2, the half-shoulder stop 313 of the TYPE 3, and/or the full-shoulder stop 314 of the TYPE 4. The vehicle 100 may control at least one component within the vehicle in order to stop the vehicle according to the determined MRM type. The vehicle 100 may store, in the memory 160, the supporting data used for determining the MRM type.

The vehicle 100 may determine whether or not the minimum risk condition is satisfied by that the speed of the vehicle becomes zero by performing the minimum risk maneuver in step S920. If the minimum risk maneuver is satisfied, the vehicle 100 may determine that an event Cl has occurred and may proceed to step S930. The vehicle 100 may determine whether the intervention of the driver is detected during the performance of the minimum risk maneuver. If the intervention of the driver is detected, the vehicle 100 may determine that an event C2 has occurred and may proceed to step S940.

The vehicle 100 may maintain a state in which the minimum risk condition is satisfied in step S930. The state in which the minimum risk condition is satisfied may mean a state in which the vehicle is stopped. For example, the vehicle 100 may maintain the stationary state of the vehicle. For example, the vehicle 100 may perform a control operation to maintain the vehicle to be in the stationary state regardless of the slope of the road surface at the stop location. The vehicle 100 may determine whether an event D1 occurs, while maintaining the state in which the minimum risk condition is satisfied. The event D1 may include at least one of ADS off by the driver and the completion of the transfer of the vehicle control authority to the driver. If the event D1 occurs, the vehicle 100 may proceed to step S940.

The vehicle 100 may switch the ADS to a standby mode or an off state in step S940. The vehicle 100 does not perform an operation for the autonomous driving while the ADS is in the standby mode or in the off state.

In steps S910, S920, S930, and S950 described above, the ADS may be in an active state, and in step S940, the ADS may be in an inactive state.

FIG. 10 is a flowchart showing that the vehicle determines the MRM strategy. Steps of FIG. 10 may be detailed steps of step S920 of FIG. 9. In the following example, respective steps may be sequentially performed, and may not be necessarily performed sequentially. For example, the order of the respective steps may be changed, and at least two steps may be performed in parallel. In addition, the following steps may be performed by the processor 130 and/or the controller 120 included in the vehicle 100, or may be implemented with instructions that can be executed by the processor 130 and/or the controller 120.

Referring to FIG. 10, the vehicle 100 may determine whether the lateral control is possible based on the vehicle state information in step S1001. For example, the vehicle 100 may monitor mechanical and/or electrical states of components (e.g., sensors, actuators, etc.) within the vehicle, and then may acquire the vehicle state information indicating whether or not mechanical and/or electrical problems occur in the components within the vehicle. On the basis of the vehicle state information indicating the mechanical and/or electrical states of the sensor and/or the actuator, the vehicle 100 may determine whether the lateral control (or steering control) of the vehicle 100 is possible.

If the lateral control is impossible, the vehicle 100 may select the straight stop as the final MRM strategy in step S1021. For example, as shown in FIG. 3, since the vehicle 100 unable to perform the lateral control can perform only the straight stop, the vehicle 100 may determine the straight stop as the final MRM strategy.

If the lateral control is possible, the vehicle 100 may determine whether a road shoulder exists within the MRC range in step S1003. For example, the vehicle 100 may determine whether a road shoulder exists by checking road information within the MRC range within a specified distance from the vehicle 100. The road information within the MRC range may be obtained from sensing data of sensors (e.g., the sensor unit 110) provided in the vehicle 100 or may be obtained from map information obtained through the communication device 150.

If the road shoulder does not exist, the vehicle 100 may determine whether lane detection is possible in step S1015. For example, since the vehicle 100 cannot perform the road shoulder stop strategy in a situation where no road shoulder exists, the vehicle 100 may check whether the lane detection is possible in order to check whether the in-lane stop is possible. The vehicle 100 may determine whether the lane detection is possible or impossible, based on the sensing value of the lane detection sensor.

If the lane detection is infeasible (e.g., impossible), the vehicle 100 may select the straight stop as the final MRM strategy in step S1021. For example, if the lane detection is infeasible (e.g., impossible), the vehicle 100 may determine that the in-lane stop cannot be performed, and may determine the straight stop as the final MRM strategy.

If the lane detection is possible, the vehicle 100 may determine whether the responsible for an accident exists in the own vehicle when the in-lane stop is deployed (or is performed), in step 1017. For example, the vehicle 100 may calculate a safe distance from a rear vehicle, and may determine a possibility of collision with the rear vehicle and whether the responsibility of an accident exists on the basis of the calculated safe distance. The rear vehicle may refer to a vehicle of the own vehicle, which travels in the same lane. The safe distance from the rear vehicle may include the longitudinal safe distance and the transverse safe distance as shown in Equation 1. If both the calculated longitudinal safe distance and the transverse safe distance are negative, the vehicle 100 may determine that there is a high possibility of collision with the rear vehicle when the in-lane stop is deployed and may determine that the responsibility of an accident exists in the own vehicle when a collision with the rear vehicle occurs. If at least one of the calculated longitudinal safe distance and the transverse safe distance is positive, the vehicle 100 may determine that there is a low possibility of collision with the rear vehicle when the in-lane stop is deployed and may determine that the responsibility of an accident does not exist in the own vehicle when a collision with the rear vehicle occurs.

If it is determined that the responsibility of an accident exists in the own vehicle when the in-lane stop is deployed, the vehicle 100 may proceed to step S1021 and may select the straight stop as the final MRM strategy.

If it is determined that the responsibility of an accident does not exist in the own vehicle when the in-lane stop is deployed, the vehicle 100 may select the in-lane stop as the final MRM strategy in step S1019.

If a road shoulder exists as a result of checking step S1003, the vehicle 100 may determine whether the size of the shoulder is larger than the size of the vehicle in step S1005. For example, the vehicle 100 may compare the width of the shoulder with the width of the vehicle and may determine whether the vehicle can perform the full-shoulder stop or the half-shoulder stop.

If the size of the shoulder is larger than the size of the vehicle, the vehicle 100 may determine that the full-shoulder stop can be performed, and may determine, in step 1007, whether the responsibility of an accident exists in the own vehicle when the full-shoulder stop is deployed. For example, the vehicle 100 may calculate a travel path for deploying the full-shoulder stop and may calculate a safe distance to at least one nearby vehicle related to the calculated travel path. At least one nearby vehicle related to the travel path for deploying the full-shoulder stop may include at least one of a side front vehicle, a side vehicle, and/or a side rear side vehicle. Based on the calculated safe distance, the vehicle 100 may determine a possibility of collision with at least one nearby vehicle and whether the responsibility of an accident exists. The safe distance to at least one nearby vehicle may include the longitudinal safe distance and the transverse safe distance as shown in Equation 1. If both the calculated longitudinal safe distance and the transverse safe distance are negative, the vehicle 100 may determine that there is a high possibility of collision with at least one nearby vehicle when the full-shoulder stop is deployed and may determine that the responsibility of an accident exists in the own vehicle when a collision with the corresponding vehicle occurs. If at least one of the calculated longitudinal safe distance and the transverse safe distance is positive, the vehicle 100 may determine that there is a low possibility of collision with at least one nearby vehicle when the full-shoulder stop is deployed and may determine that the responsibility of an accident does not exist in the own vehicle when a collision with the corresponding vehicle occurs.

If it is determined that the responsibility of an accident does not exist in the own vehicle when the full-shoulder stop is deployed, the vehicle 100 may proceed to step S1009 and may select the full-shoulder stop as the final MRM strategy.

If it is determined that the responsibility of an accident exists in the own vehicle when the full-shoulder stop is deployed, the vehicle 100 may proceed to step S1011 and may determine whether the responsibility of an accident exists in the own vehicle when the half-shoulder stop is deployed. For example, the vehicle 100 may calculate a travel path for deploying the half-shoulder stop and may calculate a safe distance to at least one nearby vehicle related to the calculated travel path. At least one nearby vehicle related to the travel path for deploying the half-shoulder stop may include at least one of a side front vehicle, a side vehicle, and/or a side rear side vehicle. Based on the calculated safe distance, the vehicle 100 may determine a possibility of collision with at least one nearby vehicle and whether the responsibility of an accident exists. The safe distance to at least one nearby vehicle may include the longitudinal safe distance and the transverse safe distance as shown in Equation 1. If both the calculated longitudinal safe distance and the transverse safe distance are negative, the vehicle 100 may determine that there is a high possibility of collision with at least one nearby vehicle when the half-shoulder stop is deployed and may determine that the responsibility of an accident exists in the own vehicle when a collision with the corresponding vehicle occurs. If at least one of the calculated longitudinal safe distance and the transverse safe distance is positive, the vehicle 100 may determine that there is a low possibility of collision with at least one nearby vehicle when the half-shoulder stop is deployed and may determine that the responsibility of an accident does not exist in the own vehicle when a collision with the corresponding vehicle occurs.

If it is determined that the responsibility of an accident does not exist in the own vehicle when the half-shoulder stop is deployed, the vehicle 100 may proceed to step S1013 and may select the half-shoulder stop as the final MRM strategy.

If it is determined that the responsibility of an accident exists in the own vehicle when the half-shoulder stop is deployed, the vehicle 100 may perform step S1017.

As described above, if the vehicle detects a situation in which normal autonomous driving is infeasible (e.g., impossible) during autonomous driving, the vehicle determines the minimum risk maneuver strategy in consideration of whether the responsibility of an accident exists for each minimum risk maneuver type on the basis of the vehicle state information and/or surrounding environment information, thereby minimizing the risk of the vehicle and improving safety.

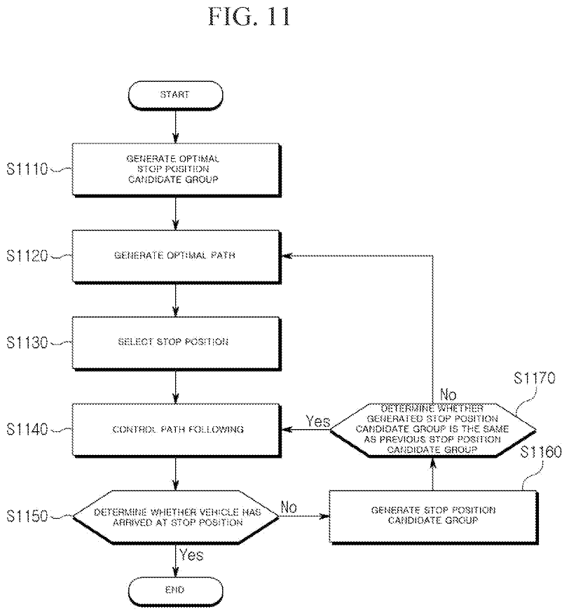

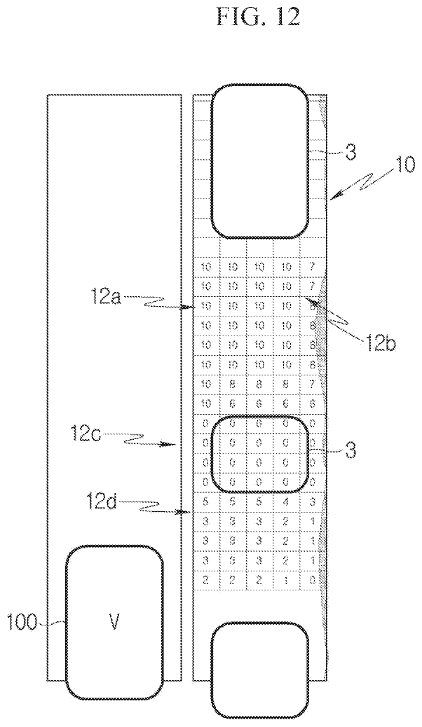

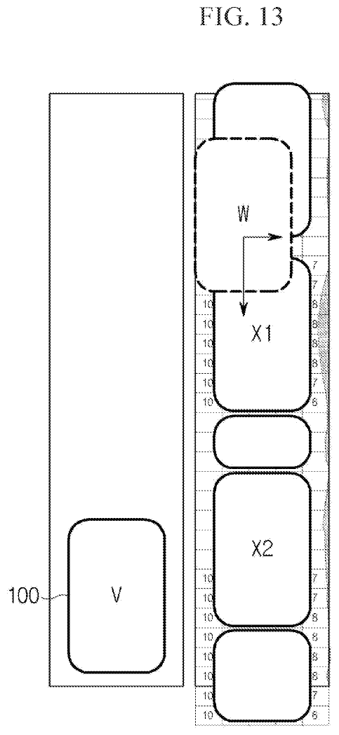

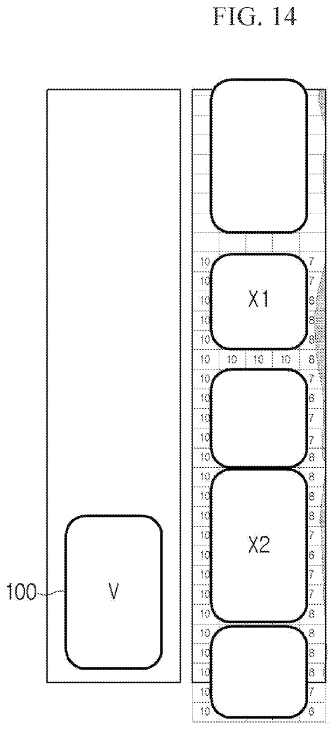

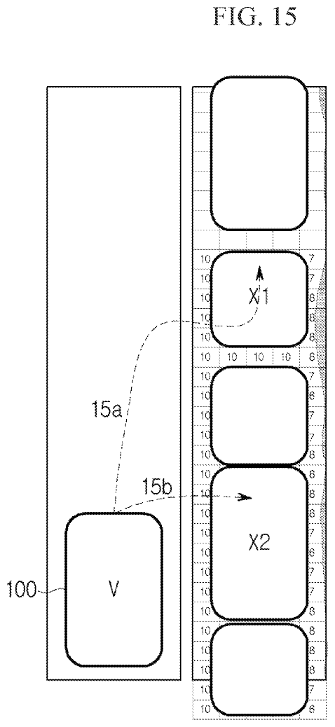

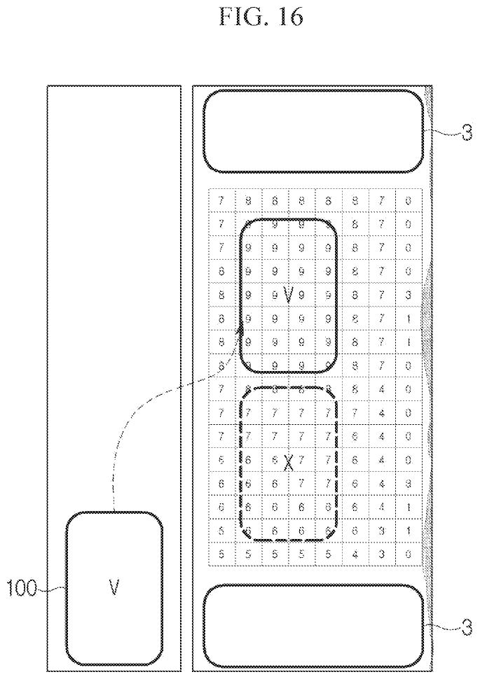

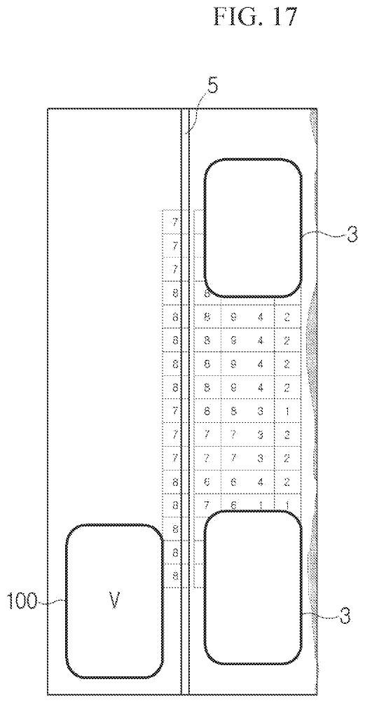

FIG. 11 is a flowchart for showing a shoulder stop operation during autonomous driving. A vehicle of FIG. 11 may be the vehicle 100 of FIG. 1. FIG. 12 shows an example in which the vehicle grids a shoulder area. FIG. 13 shows an example in which the vehicle generates an optimal stop position candidate group. FIG. 14 shows an example of the optimal stop position candidate group. FIG. 15 shows an example in which the vehicle generates an optimal path. FIGS. 16 and 17 show an example in which the vehicle generates an optimal stop position candidate group.

Referring to FIG. 11, the processor 130 may determine whether or not the minimum risk maneuver is required based on at least one of the surrounding environment information and the vehicle state information during autonomous driving of the vehicle 100. If the processor 130 determines that the minimum risk maneuver is required, the processor 130 may determine the minimum risk maneuver type. If the determined minimum risk maneuver type is the shoulder stop, the processor 130 may generate an optimal stop position candidate group in step S1110.

The shoulder stop may be the full-shoulder stop of MRM type 4 and is not limited thereto. The shoulder stop may be the half-shoulder stop of MRM type 3.

In step S1110, if the processor 130 recognizes a shoulder area on the basis of the surrounding environment information generated by the sensor unit 110, the processor 130 may partition the shoulder area into a plurality of virtual areas. In an example, as shown in FIG. 12, the processor 130 may grid the shoulder area to a certain size.

The processor 130 may assign a score to each of the partitioned virtual areas in step S1110. As shown in FIG. 12, the processor 130 may calculate the score of each of the virtual areas in consideration of at least one of a current speed of the vehicle, a free space on the shoulder, a distance from a current position of the vehicle to a stop position of the vehicle, and a distance to an obstacle. The processor 130 may assign the highest score to the virtual area having a long stopping distance in consideration of the stopping distance according to the speed of the vehicle. In order for the vehicle 100 to stop, a surrounding space of the virtual area must be wide. Therefore, when there is an obstacle around the virtual area, the processor 130 may assign a low score, and when there is no obstacle, the processor 130 may assign a high score. If there is an obstacle at a location of the virtual area, the processor 130 may assign a score of 0.

Referring to FIG. 12, in the case of an area 12a, considering the current speed of the vehicle, the stopping distance is relatively long and the size of the adjacent free space is relatively large. Therefore, ten points are assigned by the processor 130. In the case of an area 12b, the area 12b is adjacent to an obstacle (e.g., a wall) and may be assigned a lower score than that of the area 12a due to a spatial uncertainty reflected therein. In the case of an area 12c, the area 12c is an area of an obstacle 3 and may be assigned a score of 0 by the processor 130. In the case of an area 12d, since the stopping distance is insufficient when considering the current speed of the vehicle, a lower score than that of the area 12a may be assigned.

Referring to FIG. 13, the processor 130 may match a virtual window area W corresponding to the size of the vehicle to a plurality of virtual areas and may generate stop position candidate groups X1 and X2 based on a value obtained by summing the scores of the respective virtual areas included in the virtual window area W. For example, the processor 130 may substitute the virtual window area W into each virtual area (grid) and may generate the higher-order N number of stop position candidate groups according to the value obtained by summing the scores of the respective virtual areas included in the virtual window area W.

After generating the stop position candidate groups, the processor 130 may generate a path from the current position of the vehicle 100 to each of the stop position candidate groups in step S1120.

In step S1130, the processor 130 may select a final stop position by considering at least one of a travel distance of the path to each stop position candidate group, a stop characteristic of the vehicle when stopping by following the path to each stop position candidate group, and values obtained by adding the scores of the respective virtual areas of an area occupied by the vehicle when stopping by following the path to each stop position candidate group.

The processor 130 may calculate the travel distance of the path to each stop position candidate group and may assign a lower score as the distance is greater. For example, in FIG. 15, since a path 15a is greater than a path 15b, the processor 130 may assign a lower score to the path 15a than that of the path 15b.

The processor 130 may generate a first selection score for each travel distance of the path to each stop position candidate group on the basis of pre-stored map data. For example, the processor 130 may generate the first selection score for each travel distance of the path to each stop position candidate group by using map data that outputs scores according to the travel distance.

The processor 130 may follow the path to each stop position candidate group and may calculate the stop characteristic (e.g., a stop direction associated with a traveling direction) of the vehicle 100 (e.g., a parallel stop, an oblique stop, etc.) when stopping. The processor 130 may calculate the stop characteristic of the vehicle 100 based on an angle between the stop characteristic of the vehicle 100 when the vehicle 100 stops and a traveling direction. If the direction of the vehicle 100 when the vehicle 100 stops is closer to the traveling direction (the smaller the angle between the stop characteristic of the vehicle 100 when the vehicle 100 stops and the traveling direction), which may be a preferred stop characteristic, the processor 130 may assign a higher score.

For example, in FIG. 15, in the case of the path 15a, the stop characteristic of the vehicle 100 when stopping is parallel to the traveling direction, whereas, in the case of the path 15b, the stop characteristic of the vehicle 100 when stopping is perpendicular to the traveling direction (in the case of the path 15b, the angle between the stop characteristic of the vehicle 100 when stopping and the traveling direction is smaller). Therefore, the processor 130 may assign a higher score to the path 15a than that of the path 15b.

The processor 130 may generate a second selection score for each stop characteristic of the vehicle 100 when stopping by following the path to each stop position candidate group on the basis of the pre-stored map data. For example, the processor 130 may generate the second selection score for each stop characteristic of the vehicle 100 when stopping by using the map data that outputs a score according to the angle between the traveling direction of the vehicle 100 and the stop characteristic of the vehicle 100 when stopping.

The processor 130 may generate a third selection score obtained by adding the scores of the respective virtual areas of an area occupied by the vehicle when stopping by following the path to each stop position candidate group. For example, in FIG. 15, the processor 130 may generate the third selection score by summing the scores of the virtual areas included in the stop position candidate group X1. The processor 130 may generate the third selection score by summing the scores of the virtual areas included in the stop position candidate group X2.

The processor 130 may sum the first selection score, the second selection score, and the third selection score, and may select a stop position candidate group having the highest sum value among the respective stop position candidate groups as the final stop position. The processor 130 may use a path to the final stop position as a path to actually follow.

For example, in FIG. 15, if a value obtained by summing (or summing differently weighted scores of the first selection score, the second selection score, and the third selection score) the first selection score, the second selection score, and the third selection score of the stop position candidate group X1 is 8.7, and if a value obtained by summing (or the weighted summation of) the first selection score, the second selection score, and the third selection score of the stop position candidate group X2 is 6.5, the processor 130 may select the stop position candidate group X1 as the final stop position. The processor 130 may use the path 15a to the stop position candidate group X1 as a path to actually follow.

The processor 130 may transmit a path-following control command for the final stop position to the controller 120 in step S1140. For example, after selecting the stop position candidate group X1 as the final stop position, the processor 130 may transmit, to the controller 120, a control command to follow the path 15a for the stop position candidate group X1.

In step S1150, the processor 130 may determine whether the vehicle 100 has arrived at the final stop position. While the vehicle 100 is following a path to the final stop position, there may occur a situation in which the final stop position where the vehicle intends to stop disappears due to a specific situation (e.g., the movement of another vehicle that has stopped at the final stop position). For this reason, even during the path following control, it may be necessary to generate the stop position candidate group in real time and to change the stop position if necessary. However, if the scores of the stop position candidates are similar, the stop position may be changed frequently. Therefore, only when the score is not the same as that of the previously generated stop position candidate group, an optimal path can be generated and stop position selection operation can be performed.

If the processor 130 determines that the vehicle 100 fails to arrive at the final stop position in step S1160, the processor 130 may generate a stop position candidate group for changing the stop position. As an embodiment, if the vehicle 100 does not arrive at the final stop position within a preset time, the processor 130 may determine that the vehicle has failed to arrive at the final stop position.

In step S1170, if the stop position candidate group generated in step S1160 is not the same as the optimal stop position candidate group generated in step S1110 (excluding the final stop position generated in step S1130), the processor 130 may perform the optimal path generation (S1120), the stop position selection (S1130), and the path following control (S1140).

In step S1170, if the stop position candidate group generated in step S1160 is the same as the optimal stop position candidate group generated in step S1110 (excluding the final stop position generated in step S1130), the processor 130 may perform the path following control (S1140).

If the processor 130 determines that the vehicle 100 fails to arrive at the final stop position, the processor 130 may generate a stop position candidate group that is not the same as a previously generated optimal stop position candidate group. If the scores of the stop position candidates are similar, the stop position may be changed frequently. Therefore, the processor may generate a stop position candidate group that is not the same as a previously generated optimal stop position candidate group, and may perform steps S1120, S1130, and S1140.

In step S1110, not only when there is a plurality of spaces divided by the obstacle 3 and the like, but also when there is one wide space as shown in FIG. 16, the processor 130 may generate the optimal stop position candidate group.

In step S1110, the processor 130 may partition (grid) not only an outer area of a lane 5 (a right area with respect to the lane 5), but also even a portion of an inner area of the lane 5 (a left area with respect to the lane 5) as shown in FIG. 17 into a plurality of virtual areas. This grid extension can be applied to a case of an area which allows no stopping (e.g., a white solid line area).

If the processor 130 recognizes a shoulder area and a lane on the basis of the surrounding environment information generated by the sensor unit 110 in step S1110 and determines a type of a corresponding lane as a lane allowing stopping, the processor 130 may partition even a portion of the inner area of the lane into a plurality of virtual areas.

According to one or more aspects described herein, an autonomous vehicle may include: at least one sensor configured to detect surrounding environment of the vehicle and to generate surrounding environment information; a processor configured to monitor a state of the vehicle and generate vehicle state information, and to determine whether or not a minimum risk maneuver is required on the basis of at least one of the surrounding environment information and the vehicle state information during autonomous driving of the vehicle; and a controller configured to control operations of the vehicle under the control of the processor. When the processor determines that the minimum risk maneuver is required, the processor determines a minimum risk maneuver type, and when the determined minimum risk maneuver type is a shoulder stop, the processor generates a stop position candidate group.

If the processor recognizes a shoulder area on the basis of the surrounding environment information, the processor may partition the shoulder area into a plurality of virtual areas. The processor may calculate a score of each of the virtual areas in consideration of at least one of a current speed of the vehicle, a free space on the shoulder, a distance from a current position of the vehicle to a stop position of the vehicle. The processor may generate the stop position candidate group on the basis of the calculated score of each virtual area.

The processor may assign a score of 0 to an area where there is an obstacle among the plurality of virtual areas.

The processor may match a virtual window area corresponding to a size of the vehicle to the plurality of virtual areas and may generate the stop position candidate group based on a value obtained by summing the scores of the respective virtual areas included in the virtual window area.

After generating the at least one stop position candidate group, the processor may generate a path from a current position of the vehicle to each stop position candidate of the at least one stop position candidate group.

The processor may select a final stop position based on at least one of a travel distance of the path from the current position to each stop position candidate, a stop characteristic of the vehicle after following the path from the current position to each stop position candidate, or values obtained by adding scores of virtual areas of an area occupied by the vehicle after following the path from the current position to each stop position candidate.

The processor may generate a first selection score for each travel distance of the path to each stop position candidate group on the basis of pre-stored map data.

The processor may generate a second selection score for each stop characteristic of the vehicle when stopping by following the path to each stop position candidate group on the basis of the pre-stored map data.

The processor may sum the first selection score, the second selection score, and a third selection score obtained by adding the scores of the respective virtual areas of an area occupied by the vehicle when stopping by following the path to each stop position candidate group, and may select a stop position candidate group having a highest sum value among the respective stop position candidate groups as the final stop position.

The processor may transmit a path-following control command for the final stop position to the controller.

If the processor determines that the vehicle fails to arrive at the final stop position within a preset time, the processor may generate a stop position candidate group for changing the stop position.

According to one or more aspects described herein, an operation method of an autonomous vehicle is provided. The operation method may include: detecting surrounding environment of the vehicle and generating surrounding environment information during autonomous driving of the vehicle; monitoring a state of the vehicle and generating vehicle state information during the autonomous driving of the vehicle; determining whether or not a minimum risk maneuver is required on the basis of at least one of the surrounding environment information and the vehicle state information during the autonomous driving of the vehicle; and determining a minimum risk maneuver type when it is determined that the minimum risk maneuver is required, and generating a stop position candidate group when the determined minimum risk maneuver type is a shoulder stop.

The generating the stop position candidate group may include: partitioning a shoulder area into a plurality of virtual areas, when the shoulder area is recognized on the basis of the surrounding environment information; calculating a score of each of the virtual areas in consideration of at least one of a current speed of the vehicle, a free space on the shoulder, a distance from a current position of the vehicle to a stop position of the vehicle; and generating the stop position candidate group on the basis of the calculated score of each virtual area.

The generating the stop position candidate group on the basis of the calculated score of each virtual area may include matching a virtual window area corresponding to a size of the vehicle to the plurality of virtual areas and generating the stop position candidate group based on a value obtained by summing the scores of the respective virtual areas included in the virtual window area.

The operation method may further include generating a path from the current position of the vehicle to each stop position candidate of the at least one stop position candidate group, after generating the stop position candidate groups.

The operation method may further include, after generating a path from the current position of the vehicle to each stop position candidate of the at least one stop position candidate group, selecting a final stop position based on at least one of a travel distance of the path from the current position to each stop position candidate, a stop characteristic of the vehicle after following the path from the current position to each stop position candidate, or a score of each of virtual areas of an area occupied by the vehicle after by following the path from the current position to each stop position candidate.

The selecting the final stop position may include: generating a first selection score for each travel distance of the path to each stop position candidate group on the basis of pre-stored map data; generating a second selection score for each stop characteristic of the vehicle when stopping by following the path to each stop position candidate group on the basis of the pre-stored map data; and generating a third selection score by adding the scores of the respective virtual areas of an area occupied by the vehicle when stopping by following the path to each stop position candidate group.

The operation method may further include, after the generating the third selection score: summing the first selection score, the second selection score, and the third selection score; and selecting a stop position candidate group having a highest value obtained by summing the first selection score, the second selection score, and the third selection score among the respective stop position candidate groups as the final stop position.

The operation method may further include controlling the vehicle to follow a path to the final stop position, after selecting the final stop position.

The operation method may further include, after controlling the vehicle to follow a path to the final stop position, when it is determined that the vehicle fails to arrive at the final stop position within a preset time, generating a stop position candidate group for changing the stop position.

According to one or more aspects of the present disclosure, if shoulder stop is required as a minimal risk maneuver strategy while a vehicle is being autonomously driven, it is possible to obtain an optimal stop position in a variety of situations (such as obstacles, narrow shoulder spaces, many spaces available for stopping the vehicle, or the like).

As described above, if a shoulder stop is required as a minimal risk maneuver strategy while a vehicle is being autonomously driven, the vehicle can obtain an optimal stop position in a variety of situations (such as obstacles, narrow shoulder spaces, many spaces available for stopping the vehicle, or the like).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. An autonomous vehicle comprising:
at least one sensor configured to detect surrounding environment of the vehicle and to generate surrounding environment information;
a processor, during autonomous driving of the vehicle, configured to generate vehicle state information by monitoring a state of the vehicle, and to determine whether a minimum risk maneuver (MRM) is required based on at least one of the surrounding environment information and the vehicle state information; and
a controller configured to control operations of the vehicle under the control of the processor,
wherein, based on a determination that the MRM is required, the processor is configured to determine an MRM type, and when the determined MRM type is a shoulder stop, the processor is configured to generate at least one stop position candidate group.

2. The vehicle of claim 1, wherein the processor is configured to:
recognize, based on the surrounding environment information, a shoulder area, partition the shoulder area into a plurality of virtual areas,
determine a score of each of the virtual areas, wherein the score is determined based on at least one of: a speed of the vehicle, a free space on the shoulder area, or a distance from a current position of the vehicle to a stop position of the vehicle, and
generate, based on the determined score of each of the virtual areas, the at least one stop position candidate group.

3. The vehicle of claim 2, wherein the processor is configured to assign a predetermined score to a virtual area, of the plurality of virtual areas, comprising an obstacle.

4. The vehicle of claim 2, wherein the processor is configured to:
match a virtual window area corresponding to a size of the vehicle to the plurality of virtual areas; and
generate the at least one stop position candidate group based on a value obtained by summing the scores of the respective virtual areas included in the virtual window area.

5. The vehicle of claim 1, wherein the processor is configured to:
after generating the at least one stop position candidate group, generate a path from a current position of the vehicle to each stop position candidate of the at least one stop position candidate group.

6. The vehicle of claim 5, wherein the processor is configured to:
select a final stop position based on at least one of: a travel distance of the path from the current position to each stop position candidate, a stop characteristic of the vehicle after following the path from the current position to each stop position candidate, or values obtained by adding scores of virtual areas of an area occupied by the vehicle after following the path from the current position to each stop position candidate.

7. The vehicle of claim 6, wherein the processor is configured to generate, based on stored map data, a first selection score for each travel distance that is based on the path from the current position to a respective stop position candidate.

8. The vehicle of claim 7, wherein the processor is configured to generate, based on the stored map data, a second selection score for each stop characteristic of the vehicle after following the path from the current position to a respective stop position candidate.

9. The vehicle of claim 8, wherein the processor is configured to: generate, for a respective stop position candidate, a final score based on the first selection score, the second selection score, and a third selection score that is obtained by adding the scores of the respective virtual areas of an area occupied by the vehicle after following the path from the current position to a respective stop position candidate, and
select, as the final stop position, a stop position candidate having a highest final score among the final scores of the respective stop position candidates.

10. The vehicle of claim 6, wherein the processor is configured to transmit, to the controller, a path-following control command for the final stop position.

11. The vehicle of claim 10, wherein the processor is configured to generate, based on a determination that the vehicle fails to arrive at the final stop position within a preset time, a stop position candidate group for changing the stop position.

12. An operation method of an autonomous vehicle, the operation method comprising:
during autonomous driving of the vehicle:
generating surrounding environment information by detecting surrounding environment of the vehicle;
generating vehicle state information by monitoring a state of the vehicle;
determining whether a minimum risk maneuver (MRM) is required based on at least one of the surrounding environment information and the vehicle state information; and
determining an MRM type based on a determination that the MRM is required, and generating at least one stop position candidate group when the determined MRM type is a shoulder stop.

13. The operation method of claim 12, wherein the generating the at least one stop position candidate group comprises:
partitioning, based on a shoulder area being recognized from the surrounding environment information, the shoulder area into a plurality of virtual areas;
determining a score of each of the virtual areas, wherein the score is determined based on at least one of: a speed of the vehicle, a free space on the shoulder area, or a distance from a current position of the vehicle to a stop position of the vehicle; and
generating, based on the determined score of each of the virtual areas, the at least one stop position candidate group.

14. The operation method of claim 13, wherein the generating the at least one stop position candidate group comprises:
matching a virtual window area corresponding to a size of the vehicle to the plurality of virtual areas; and
generating the at least one stop position candidate group based on a value obtained by summing the scores of the respective virtual areas included in the virtual window area.

15. The operation method of claim 12, further comprising:
after generating the at least one stop position candidate group, generating a path from a current position of the vehicle to each stop position candidate of the at least one stop position candidate group.

16. The operation method of claim 15, further comprising:
after generating a path from the current position of the vehicle to each stop position candidate of the at least one stop position candidate group, selecting a final stop position based on at least one of: a travel distance of the path from the current position to each stop position candidate, a stop characteristic of the vehicle after following the path from the current position to each stop position candidate, or a score of each of virtual areas of an area occupied by the vehicle after following the path from the current position to each stop position candidate.

17. The operation method of claim 16, wherein the selecting the final stop position comprises:
generating, based on stored map data, a first selection score for each travel distance that is based on the path from the current position to a respective stop position candidate;
generating, based on the stored map data, a second selection score for each stop characteristic of the vehicle after following the path from the current position to a respective stop position candidate; and
generating a third selection score by adding the scores of the respective virtual areas of an area occupied by the vehicle after following the path from the current position to a respective stop position candidate.

18. The operation method of claim 17, further comprising: after the generating the third selection score:
generating, for a respective stop position candidate, a final score based on the first selection score, the second selection score, and the third selection score; and
selecting, as the final stop position, a stop position candidate having a highest final score among the final scores of the respective stop position candidates.

19. The operation method of claim 16, further comprising:
after selecting the final stop position, controlling the vehicle to follow a path to the final stop position.

20. The operation method of claim 19, further comprising: after controlling the vehicle to follow the path to the final stop position, generating, based on a determination that the vehicle fails to arrive at the final stop position within a preset time, a stop position candidate group for changing the stop position.
